(19) United States
(12) Patent Application Publication
(10) Pub. No.: US 2003/0165731 A1
(43) Pub. Date: Sep. 4, 2003

(54) Coated fuel cell electrical contact element

(76) Inventors: Gayatri Vyas, Rochester Hills, MI (US); Hubert A. Gasteiger, Rochester, NY (US); Youssef Mikhail, Sterling Heights, MI (US)

Correspondence Address: HARNESS, DICKEY & PIERCE, P.L.C., P.O. BOX 828, BLOOMFIELD HILLS, MI, 48303, US

(21) Appl. No.: 10/087,677

(22) Filed: Mar. 1, 2002

(51) Int. Cl. H01M 4/86; H01M 4/96

(52) U.S. Cl. 429/44

(57) ABSTRACT

A fuel cell comprising an ion conducting membrane, a catalytic electrode on one face of the membrane, a catalytic electrode on the other face of the membrane, and an electrically conductive contact element having a first surface facing at least one of the electrodes for conducting electrical current from the electrode, where the contact element comprises an electrically conductive substrate and an electrically conductive coating comprising a doped metal oxide, desirably a doped tin oxide, and preferably a fluorine doped tin oxide.

### FIELD OF THE INVENTION

The present invention relates to fuel cells, and more particularly to electrical contact elements for such cells.

### BACKGROUND OF THE INVENTION

Fuel cells have been proposed as a power source for electric vehicles and other applications. One known fuel cell is the PEM (i.e., Proton Exchange Membrane) fuel cell that includes a so-called “membrane-electrode-assembly” comprising a thin, solid polymer membrane-electrolyte having an anode on one face of the membrane-electrolyte and a cathode on the opposite face of the membrane-electrolyte. The anode and cathode typically comprise finely divided carbon particles, very finely divided catalytic particles supported on the internal and external surfaces of the carbon particles, and proton conductive material intermingled with the catalytic and carbon particles. One such membrane-electrode assembly and fuel cell is described in U.S. Pat. No. 5,272,017 issued Dec. 21, 1993 and assigned to the assignee of the present invention. The membrane-electrode-assembly is sandwiched between a pair of electrically conductive contact elements which serve as current collectors for the anode and cathode. Flow fields are provided for distributing the fuel cell's gaseous reactants over surfaces of the respective anode and cathode. The electrical contact elements may themselves form a part of the flow field in the form of appropriate channels and openings therein for distributing the fuel cell's gaseous reactants (i.e., H₂ & O₂) over the surfaces of the respective anode and cathode.

A fuel cell stack comprises a plurality of the membrane-electrode-assemblies stacked together in electrical series. The membrane-electrode-assemblies are separated from one another by an impermeable, electrically conductive contact element, known as a bipolar plate. The bipolar plate has two major surfaces, one facing the anode of one cell and the other surface facing the cathode on the next adjacent cell in the stack. The plate electrically conducts current between the adjacent cells. Contact elements at the ends of the stack contact only the end cells and are referred to as end plates.

In a PEM fuel cell environment that employs H₂ and O₂ (optionally air), the bipolar plates and other contact elements (e.g., end plates) are in constant contact with acidic solutions (pH 3 to 5).

In addition, the fuel cell operates at elevated temperature on the order of 60° C. to 100° C. Moreover, the cathode operates in a highly oxidizing environment, being polarized to about +1 V (in comparison to a normal hydrogen electrode, i.e., the anode) while being exposed to pressurized air. The anode is constantly exposed to a harsh environment of pressurized hydrogen. Hence, many of the conventional contact elements are made from metal and must be resistant to acids, oxidation, and hydrogen embrittlement in the fuel cell environment. Metals which meet this criteria are costly. One proposed solution has been to fabricate the contact elements from graphite, which is corrosion-resistant, and electrically conductive, however, graphite is quite fragile and difficult to machine.

Lightweight metals such as aluminum and titanium and their alloys, as well as stainless steel, have also been proposed for use in making fuel cell contact elements. Such metals are more conductive than graphite, and can be formed into very thin plates. Unfortunately, such lightweight metals are susceptible to corrosion in the hostile fuel cell environment, and contact elements made therefrom either dissolve (e.g., in the case of aluminum), or form highly electronically resistive, passivating oxide films on their surface (e.g., in the case of titanium or stainless steel) that increases the internal resistance of the fuel cell and reduces its performance. To address this problem it has been proposed to coat the lightweight metal contact elements with a layer of metal or metal compound which is both electrically conductive and corrosion resistant to thereby protect the underlying metal. See for example, U.S. Pat. No. 5,624,769 by Li et al., which is assigned to the assignee of the present invention, and discloses a light metal core, a stainless steel passivating layer atop the core, and a layer of titanium nitride (TiN) atop the stainless steel layer.

Another type of contact element, a bipolar plate, is molded from a polymer resin and has a conductive carbon or graphite powder embedded therein for electrical conductivity. Such material is typically 80% carbon and 20% polymer on a weight basis. Since these materials cannot be fabricated as thin metal substrates, the volumetric power density of stacks using these plates is usually low and they are not widely used. Examples of such composite plates can be found in U.S. Pat. Nos. 6,096,450, 6,103,413 and 6,248,467. Still another type of plate is graphoil, exfoliated graphite, flake material processed as a graphite plate embossed to a final shape and impregnated with a resin. Such material is typically 99% carbon and 1% resin filler.

### SUMMARY OF THE INVENTION

In one aspect of the present invention, there is provided a fuel cell comprising an ion conducting membrane, a catalytic electrode on one face of the membrane, a catalytic electrode on the other face of the membrane, and an electrically conductive contact element having a first surface facing at least one of the electrodes for conducting electrical current from the electrode, where the contact element comprises an electrically conductive substrate and an electrically conductive coating comprising a doped metal oxide, desirably a doped tin oxide, and preferably a fluorine doped tin oxide.

In one variation, the electrically conductive substrate comprises a metal susceptible to corrosion, and the coating is a corrosion-resistant protective coating which protects the substrate from the corrosive environment of the fuel cell.

In another variation, the electrically conductive substrate comprises electrically conductive particles dispersed in a binder matrix, and the electrically conductive coating provides electrical contact between the substrate and the next adjacent layer. Preferably, the coating has a conductivity at least equivalent to or greater than the substrate.

Preferably, the fuel cell further includes a thin layer of porous material, such as carbon paper or carbon cloth, disposed between the electrode and the electrically conductive contact element, and the coating enhances or at least maintains electrical conductivity between the contact element and the porous material.

In another aspect, there is provided an electrically conductive fluid distribution element for an electrochemical cell which comprises an electrically conductive substrate having first and second major surfaces, a flow field at the first surface for distributing fluid along the first surface, and an electrically conductive coating on the first surface which comprises a doped metal oxide, desirably a doped tin oxide, and preferably a fluorine doped tin oxide film.

Preferably, the substrate is selected from the group consisting of titanium, stainless steel, aluminum, and a composite-of electrically conductive particles dispersed in a binder matrix.

In one variation, the electrically conductive fluid distribution element has a substrate which is essentially planar and the flow field comprises a layer of electrically conductive foam. Preferably, the foam is an open cell foam, most preferably the foam is conductive graphite foam or conductive metallic foam.

In still another embodiment, the foam is protected by a coating. Here, CVD or other electro-deposition methods are used to coat the three dimensional foam structure. The coated foam is attached to a impervious barrier sheet. The foam may be coated to a desired depth inward from the exposed surface of the foam. Such an electroconductive coating may comprise a doped metal oxide, desirably a doped tin oxide, and preferably a fluorine doped tin oxide. In another alternative, essentially all the internal surfaces of the foam are coated with the coating. In a preferred embodiment, only the outer surface of the foam is coated since such outer surface is exposed to the corrosive elements of the membrane-electrode assembly.

Metal foams such as stainless steel foams which do not chemically decompose are preferably protected at the surface of the foam or to some selected depth. Other metal foams such as aluminum foams which are subject to chemical dissolution are preferably coated throughout, which includes coating from the outer surface of the foam, throughout its thickness, and to the inner surface of the foam facing the planar element.

Preferably, the coating of the present invention comprises a doped tin oxide. The dopant is selected to provide “extra” electrons which contribute to the conductivity. The preferred dopant is fluorine. Other dopants such as antimony, indium, or chlorine may also be used. However, fluorine is known to provide a relatively low resistivity oxide film. The amount of fluorine dopant in the tin oxide coating is selected to provide the desired conductivity. Any amount of fluorine will enhance conductivity. Generally it has been found that less than 10 weight percent of fluorine is desired.

In another variation, the flow field comprises a series of channels in the first major surface. Preferably, the flow field comprises lands defining a plurality of grooves for distributing fuel or oxidant along the first surface of the substrate. Preferably, the element comprises a second flow field at a second surface, and the second flow field comprises lands defining a plurality of grooves for distributing coolant fluid along the second surface.

The contact element has a working face, or surface, that serves to conduct electrical current from its associated electrode. In one aspect, the contact element comprises a corrosion-susceptible metal substrate, having an electrically conductive, corrosion-resistant, protective coating on the working face to protect the substrate from the corrosive environment of the fuel cell. A “corrosion susceptible metal” is a metal that is either dissolved by, or oxidized/passivated by, the cell's environment. Correspondingly, the reference to corrosion herein encompasses degradation by acid attack, dissolution, oxidation and passivation, as well as other known mechanisms of degradation, and enhanced by the presence of anodic or cathodic dissolution.

An oxidizable metal layer may be dispersed over a dissolvable metal substrate, and underlie the protective coating layer. This is described in U.S. Pat. No. RE 37,284, reissue of U.S. Pat. No. 5,624,769 owned by the assignee of the present invention.

In another aspect, the coating of the present invention serves to facilitate electrical contact between the substrate and the next adjacent layer in a fuel cell. For example, electrical conductivity is enhanced or at least maintained between a substrate, such as a composite, and a porous conductive layer such as a carbon cloth.

The coating preferably has a resistivity on the order of no greater than about 0.001 ohm-cm, and approaching 0.0001 ohm-cm as in a metal. The coating preferably has a thickness between about 1 micron and about 10 microns depending on the composition, resistivity and integrity of the coating. Thinner coatings (i.e., about 0.1 to 1 micron) are useable and selection depends on cost and other considerations. Thicker coatings provide more protection and lessen the incidence of pinholes.

The coating may be applied in a variety of ways including: CVD PVD, spray pyrolysis, dip coating and spray coating.

In another aspect, there is provided a method for preventing or at least inhibiting degradation of an electrically conductive element in a fuel cell which has proton conductive material with pendant groups which release acid forming species. Such proton conductive material degrades leading to formation of a corrosive environment in the cell. The method comprises placing a layer or barrier between the proton conductive material and the electrically conductive contact element. The layer or barrier comprising fluorine doped tin oxide inhibits acid attack, corrosion, or degradation of the electrically conductive contact element. The proton conductive material may comprise perfluoronated sulfonic acid polymer, or a mixture of perfluoronated sulfonic acid polymer and polytetrafluoroethylene (Teflon). Teflon is composed of long chains of linked CF₂ units.

The protective coating and its associated assembly are also useful for electrolytic cells where voltage is applied to the cell. Here, the same problem of electrical element degradation exists. Therefore, the invention is useful for electrochemical cells, generally.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will better be understood when considered in the light of the following detailed description and the several figures in which:

FIG. 1 is a schematic, exploded, isometric, illustration of a liquid-cooled PEM fuel cell stack (only two cells shown);

FIG. 2 is an exploded, isometric view of an exemplary bipolar plate with flow field channels useful with PEM fuel cell stacks like that illustrated in FIG. 1;

FIG. 3 is a sectioned view in the direction 3-3 of FIG. 2; and

FIG. 4 is a magnified portion of the bipolar plate of FIG. 3;

FIG. 5 is a partial cross-section of a bipolar plate. This design features a thin substrate made from a solid metal sheet with foamed metal flow fields attached to both sides of it. The substrate sheet is coated.

FIG. 6 is a partial cross-section of a bipolar plate. This design features a thin substrate made from a solid metal sheet with foamed metal flow fields attached to both sides of it. The interior and exterior surfaces of the foam including each face of the foam are coated throughout.

FIG. 7 is a partial cross-section of a bipolar plate. This design features a thin substrate made from a solid metal sheet with foamed metal flow fields attached to both sides of it. The exterior surfaces of the foam are coated to a desired depth.

### DETAILED DESCRIPTION OF THE PREFERRED EMBODIMENTS

The following description of the preferred embodiment(s) is merely exemplary in nature and is in no way intended to limit the invention, its application, or uses.

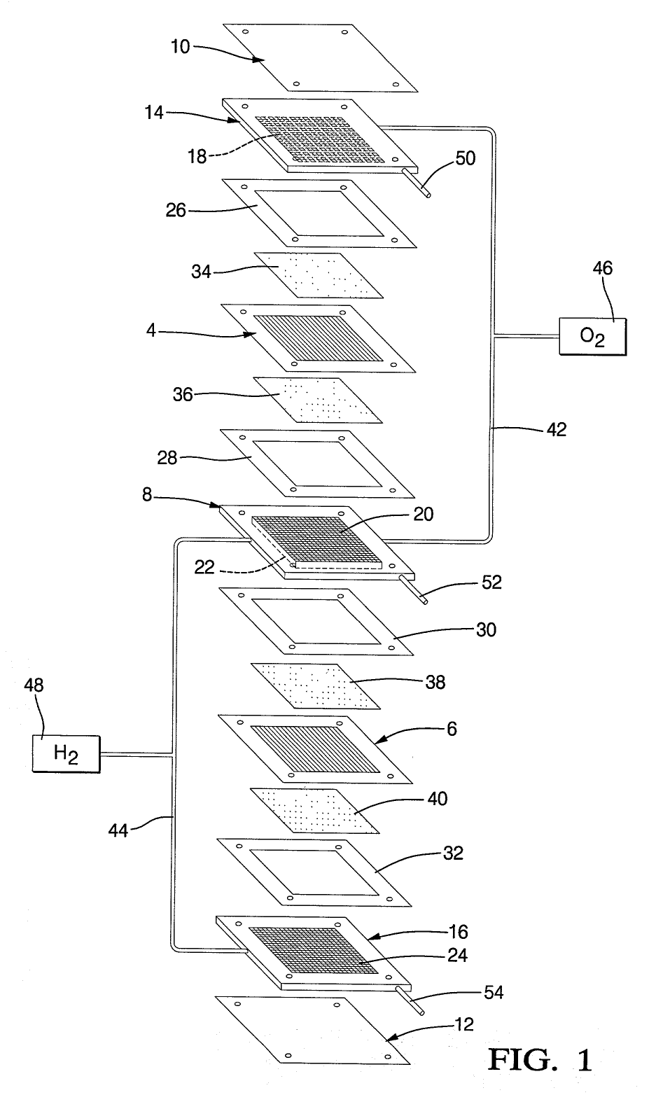

FIG. 1 depicts a two cell, bipolar fuel cell stack having a pair of membrane-electrode-assemblies (MEAs) 4 and 6 separated from each other by an electrically conductive, liquid-cooled, bipolar plate 8. The MEAs 4 and 6, and bipolar plate 8, are stacked together between stainless steel clamping plates, or end plates, 10 and 12, and end contact elements 14 and 16. The end contact elements 14 and 16, as well as both working faces of the bipolar plate 8, contain a plurality of grooves or channels 18, 20, 22 and 24, respectively, for distributing fuel and oxidant gases (i.e., H₂ and O₂) to the MEAs 4 and 6. Nonconductive gaskets 26, 28, 30, and 32 provide seals and electrical insulation between the several components of the fuel cell stack. Gas permeable conductive materials are typically carbon/graphite diffusion papers 34, 36, 38, and 40 press up against the electrode faces of the MEAs 4 and 6. The end contact elements 14 and 16 press up against the carbon/graphite papers 34 and 40 respectively, while the bipolar plate 8 presses up against the carbon/graphite paper 36 on the anode face of MEA 4, and against carbon/graphite paper 38 on the cathode face of MEA 6. Oxygen is supplied to the cathode side of the fuel cell stack from storage tank 46 via appropriate supply plumbing 42, while hydrogen is supplied to the anode side of the fuel cell from storage tank 48, via appropriate supply plumbing 44. Alternatively, ambient air may be supplied to the cathode side as an oxygen source and hydrogen to the anode from a methanol or gasoline reformer, or the like. Exhaust plumbing (not shown) for both the H₂ and O₂ sides of the MEAs will also be provided. Additional plumbing 50, 52 and 54 is provided for supplying liquid coolant to the bipolar plate 8 and end plates 14 and 16. Appropriate plumbing for exhausting coolant from the plate 8 and end plates 14 and 16 is also provided, but not shown.

As mentioned earlier, the membrane-electrode-assembly (MEA) comprises a proton conductive membrane having electrodes on its opposite faces. The proton conductive membrane may be solid polymer electrolytes (SPE), such as the SPE membranes described in U.S. Pat. Nos. 4,272,353 and 3,134,697. The electrodes also comprise proton conductive material. The bipolar plates adjacent the MEAs are susceptible to decomposition by acid attack, fluoride ions and/or anodic or cathodic dissolution. Acidity and fluorides are thought to be the main decomposition products present within the cell environment. In particular they are generated from the degradation of the SPE membranes. The SPE membranes or sheets are ion exchange resin membranes. The resins include at least two ionic groups, one being fixed within the resins and the other being mobile. In particular, the mobile ion may be replaceable under certain conditions.

The ion exchange resins can be prepared by polymerizing a mixture of ingredients, one of which contains an ionic constituent. One broad class of cation exchange used in proton conductive resins is the so-called sulfonic acid cation exchange resin. In the sulfonic acid membranes, the cation exchange groups are hydrated sulfonic acid radicals that are attached to the polymer backbone by sulfonation.

The formation of the ionic exchange resins is well known in the art and may include the entire membrane having the ion exchange characteristics. One commercially available membrane is the proton conductive membrane sold by E. I. DuPont De Nemours & Co. under the trade name NAFION. Such proton conductive membranes may be characterized by monomers of the structures: CF₂═CFOCF₂CF₂SO₃H and CF₂═CFOCF₂C(CF₃)FOCF₂SO₃H. The characteristics of such ion exchange resins result in the presence of chemical compounds within the cell that attack less electronegative compounds, such as metals.

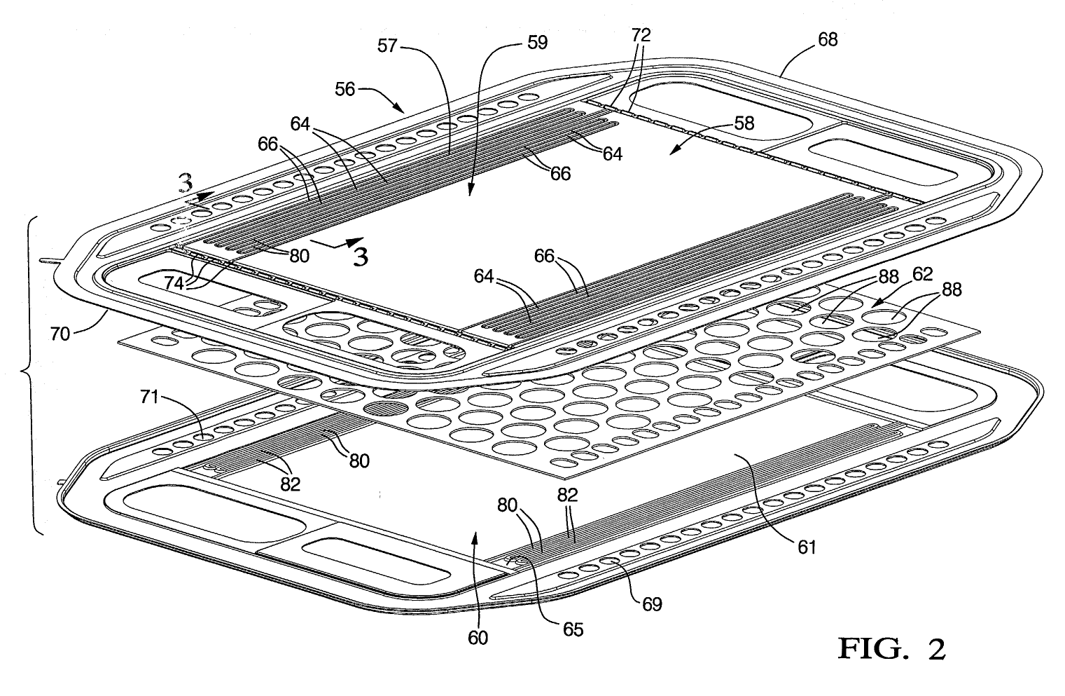

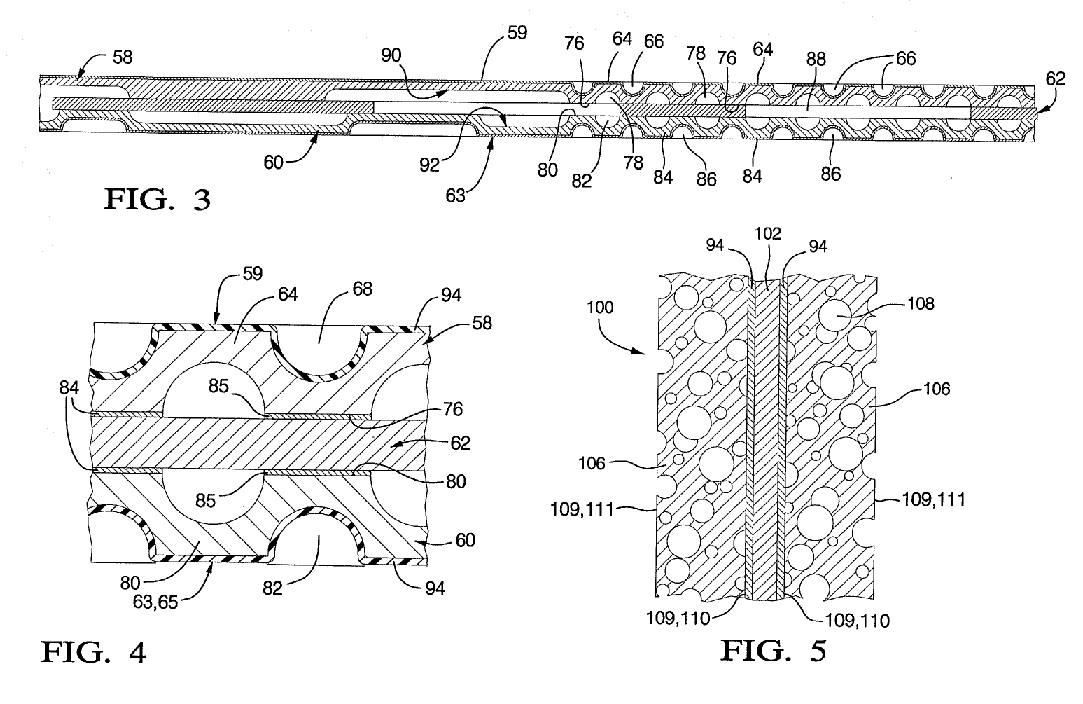

FIG. 2 is an isometric, exploded view of an exemplary bipolar plate 56, which would form bipolar plate 8 in FIG. 1, comprising a first exterior metal sheet 58, a second exterior metal sheet 60, and an interior spacer metal sheet 62 interjacent the first metal sheet 58 and the second metal sheet 60. The exterior metal sheets 58 and 60 are made as thin as possible (e.g., about 0.002-0.02 inches thick) and may be formed by stamping, by photo etching (i.e., through a photolithographic mask), or any other conventional process for shaping sheet metal. The external sheet 58 has a first working face 59 on the outside thereof which confronts a membrane-electrode-assembly (not shown) and is formed so as to provide flow field 57. The flow field 57 is defined by a plurality of lands 64 which define therebetween a plurality of grooves 66 which constitutes the “flow field” through which the fuel cell's reactant gases (i.e., H₂ or O₂) flow in a tortuous path from one side 68 of the bipolar plate to the other side 70 thereof. When the fuel cell is fully assembled, the lands 64 press against the porous material, carbon/graphite papers 36 or 38 (see FIG. 1) which, in turn, press against the MEAs 4 and 6 respectively. For drafting simplicity, FIG. 2 depicts only two arrays of lands and grooves. In reality, the lands and grooves will cover the entire external faces of the metal sheets 58 and 60 that engage the carbon/graphite papers 36 and 38. The reactant gas is supplied to grooves 66 from a header or manifold groove 72 that lies along one side 68 of the fuel cell, and exits the grooves 66 via another header/manifold groove 74 that lies adjacent the opposite side 70 of the fuel cell. As best shown in FIG. 3, the underside of the sheet 58 includes a plurality of ridges 76 which define therebetween a plurality of channels 78 through which coolant passes during the operation of the fuel cell. As shown in FIG. 3, a coolant channel 78 underlies each land 64 while a reactant gas groove 66 underlies each ridge 76. Alternatively, the sheet 58 could be flat and the flow field formed in a separate sheet of material.

Metal sheet 60 is similar to sheet 58. The internal face 61 (i.e., coolant side) of sheet 60 is shown in FIG. 2. In this regard, there is depicted a plurality of ridges 80 defining therebetween a plurality of channels 82 through which coolant flows from one side 69 of the bipolar plate to the other 71. Like sheet 58 and as best shown in FIG. 3, the external side of the sheet 60 has a working face 63. Sheet 60 is formed so as to provide flow field 65. The flow field 65 is defined by a plurality of lands 84 thereon defining a plurality of grooves 86 which constitute the flow field 65 through which the reactant gases pass. An interior metal spacer sheet 62 is positioned interjacent the exterior sheets 58 and 60 and includes a plurality of apertures 88 therein to permit coolant to flow between the channels 82 in sheet 60 and the channels 78 in the sheet 58 thereby breaking laminar boundary layers and affording turbulence which enhances heat exchange with the inside faces 90 and 92 of the exterior sheets 58 and 60 respectively. Thus, channels 78 and 82 form respective coolant flow fields at the interior volume defined by sheets 58 and 60.

FIG. 4 is a magnified view of a portion of FIG. 3 and shows the ridges 76 on the first sheet 58, and the ridges 80 on the second sheet 60 bonded by binder 85 to the spacer sheet 62.

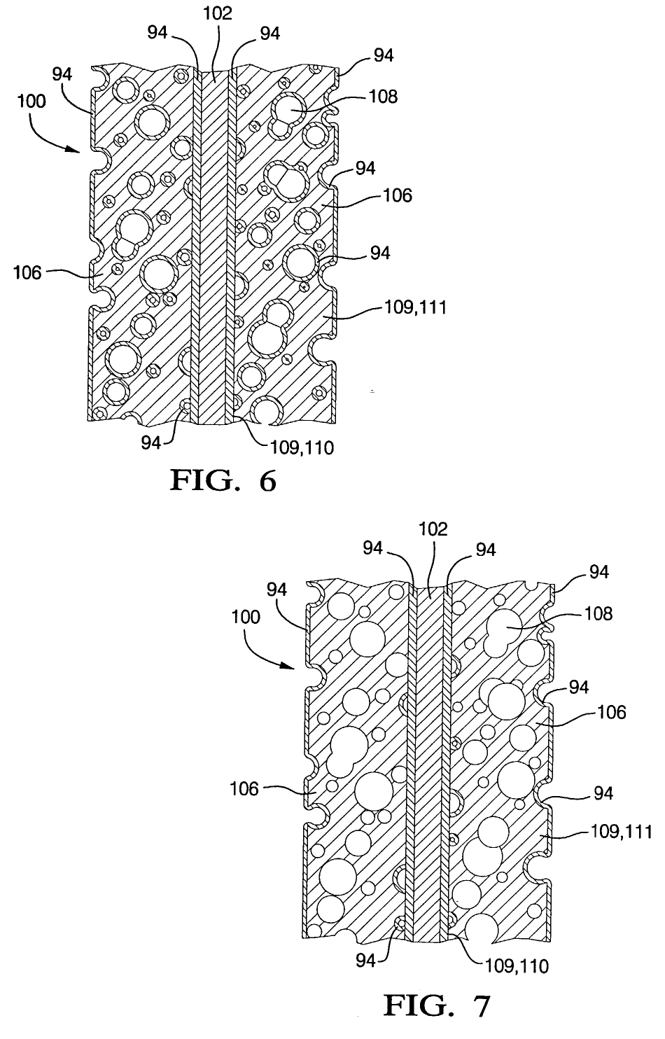

In accordance with the present invention, and as best shown in FIG. 4, the working faces 59 and 63 of the bipolar plate are covered with an electrically conductive, oxidation resistant, and acid-resistant coating 94 comprising a doped metal oxide. A preferred coating 94 is tin oxide. The dopant is selected to provide “extra” electrons which contribute to the conductivity. The preferred dopant is fluorine. Other dopants such as antimony, indium, or chlorine are also useable. However, fluorine is known to provide relatively low resistivity oxide film. The amount of fluorine dopant in the tin oxide coating is selected to provide the desired conductivity. Any amount of fluorine will enhance conductivity. A typical curve of fluorine to oxygen ratio in a film versus electrical conductivity is shown in FIG. 6 of U.S. Pat. No. 4,146,657, by Roy Gordon and commonly assigned ('657 Gordon). Generally it has been found that less than 10 weight percent of fluorine is desired.

In one embodiment, the substrate forming the contact element comprises a corrosion-susceptible metal such as (1) aluminum which is dissolvable by the acids formed in the cell, or (2) titanium or stainless steel which are oxidized/passivated by the formation of oxide layers on their surfaces. In accordance with one embodiment of the invention, the coating is applied directly to the substrate metal.

In another aspect, optionally, one or more layers are disposed between the coating and the substrate, or the substrate itself has multiple layers. For example, the substrate metal comprises an acid soluble metal (e.g., Al) that is covered with an oxidizable metal (e.g., stainless steel) before the electrically conductive protective topcoat is applied. See for example U.S. Pat. No. RE 37,284. In another variation, TiO (titanium oxide) is applied to the substrate as a layer before the fluorine doped tin oxide coating is applied.

In another embodiment, the substrate forming the contact element comprises an electrically conductive composite material. Preferably the electrically conductive composite material is a polymer having conductive powder embedded therein to form an electrically conductive contact material. The conductive particles are typically graphite carbon or metal. Examples can be found in the art, for example see U.S. Pat. Nos. 6,096,450, 6,103,413, and 6,248,467. The conductive coating of the present invention is applied to enhance electrical contact between the composite element and the next adjacent fuel cell element.

In still another embodiment, a cross-sectional view of an electrically conductive element 100 is shown in FIG. 5. The element 110 functions as a bipolar plate, constructed with a thin, substrate sheet 102 having foam flow fields 106. This bipolar plate features a thin barrier sheet 102, preferably made from a solid titanium metal sheet, with foam (about one-half to about 3 millimeters thick) attached as by welding or brazing to both sides thereof. The sheet 102 forms the gas barrier and the foam 106 forms the fluid flow fields. As can be seen, foam 106 has opposed major surfaces 110 and 111. Foam 106 has one major surface 110 facing the metal sheet 102 and another major surface 111 opposite 110. Typically, major surface 111 faces the MEA. As shown in FIGS. 5, 6 and 7, major surface 111 forms the outer surface of electrically conductive element 100. Foams can be prepared as metal foams or carbon-based (graphite) foams. Metals that can be prepared as a solid foam in accordance with the present invention include copper, aluminum, nickel, titanium, silver, and stainless steel, with the preferred metals being nickel and stainless steel. Here, the doped tin oxide film 94 is applied to sheet 102 as shown in FIG. 5. A variety of foamed metals are available from AstroMet, located in Cincinnati, Ohio. Methods for producing these metal foams are described in U.S. Pat. No. 4,973,358. Carbon-based foams are available from Ultra Met.

In other embodiments, the coating of the substrate and foam vary depending on the characteristics of each of them. Depending on the material of construction and the arrangement of the substrate and foam it may be desirable to coat all of the surfaces of the substrate when a metal sheet is used. In the case of metal foams there is the option to coat all of the internal and external surfaces of the foam, or the option to coat just some of the surfaces. It should be understood that the foam being described herein is an open cell foam. This indicates that there are continuous flow paths or channels throughout the foam created by contiguous openings, or pores, which are open to one another through the thickness of the foam. External surfaces 109 of the foam refer to the aforesaid major surfaces such as 109 which include openings formed by surface pores. Internal surfaces of the foam are surfaces formed by the internal openings or pores 108 as shown in FIG. 5. Since these openings are disposed internally within the foam, the surfaces of the openings are referred to as internal surfaces.

In one embodiment, it is possible to coat all of the internal opening 108, all the external surfaces 109 of the foam facing the MEA and facing the substrate planar sheet 102. (FIG. 6) If a chemically unstable foam such as aluminum foam is used, this would be desired. Optionally, the surfaces of sheet 102 are also coated. If a more chemically stable foam such as stainless steel is used, the coating of internal and external surfaces of the foam may not be necessary depending on the environment of the cell. In this case, the foam interior may remain uncoated or be coated to a given depth. Preferably, the coating is applied to the parts of the foam which are required to transfer electrons from one medium to the next, for example, from the foam surface 111 to the MEA or from the foam surface 110 to the planar sheet 102. As can be seen, in this embodiment, the coating 94 is applied to the electrically conductive element where electrons flow into and out from the structure of the electrically conductive element 100. (FIG. 7) Once electrons are flowing through the structure of the element 100, i.e., the foam, there is no resistance within the foam and the next encountered region of resistance is met where the electrons exit the foam toward or at the surface of the metal sheet 102. In this embodiment, coating 94 is applied to the major surface 111 of the foam 106 to a micron depth level. In addition in this embodiment it is desirable to also coat the foam to a micron depth level at major surface 110 where it faces the planar sheet metal 102.

In yet another embodiment where the foam 106 is essentially metallurgically attached to the sheet metal plate 102 such as by braising or welding, the problem of contact resistance is obviated or is slight and it is not necessary to coat the surface region 110 of the foam 106 which is metallurgically attached or bonded to the sheet metal plate 102. This embodiment is not shown but is easily understood referring to FIG. 7. This embodiment is similar to that shown in FIG. 7, except that coating 94 is not present on surface 110 of the foam 106 facing and attached to substrate 102.

It will be evident that the application of coating to any combination of surfaces of foam and planar sheet is contemplated and further that coating of the foam to any desired extent throughout its thickness is also contemplated.

The coating 94 may be applied in a variety of ways. Chemical Vapor Deposition (CVD) or Physical Vapor Deposition (PVD) deposited coatings are particularly advantageous because they can be quickly deposited in an automated process with little waste, and can be deposited substantially uniformly onto substrates. CVD is preferred for substrates having complex recessed surfaces like those used to form the reactant flow fields on the working face(s) of the contact elements. CVD and PVD are well-known processes useful to coat a variety of conductive substrates such as automobile and truck bodies. CVD technology is discussed in a variety of publications including “WO 96/11802 owned by Libbey Owens based on priority U.S. Application having the Ser. No. 08/323,272. A preferred deposition process is described in '657 Gordon. According to Gordon, a particular feature of the deposition is to select the reactants in such a way that the required tin-fluorine bond is not formed until the deposition is imminent. Thus, the tin fluoride material is maintained in the vapor phase and at temperatures low enough that oxidation of the compound occurs only after the rearrangement to form a tin-fluorine bond. Films of fluorine-doped tin oxide, thus formed, have very low electrical resistivity. In the process described in '657 Gordon, controlled amounts of fluorine impurity are introduced into the growing tin oxide film. The fluorine dopant is a vapor containing one tin-fluorine bond in each molecule. The other three tin valences are satisfied by organic groups and/or halogens other than fluorine. Typical of such compounds is tributyltin fluoride. In the '657 Gordon process the bound fluorine, can be made available to a hot surface in vapor form, and is not cleaved from the tin during oxidation at a hot surface. More specifically, the '657 Gordon deposition process forms the fluorine dopant from volatile compounds which do not have the required tin-fluorine bond, but which will rearrange on heating to form a direct tin-fluorine bond. This rearrangement advantageously occurs at temperatures high enough (e.g., >100° C.) so that the tin fluoride thus formed remains in the vapor phase, but also low enough (e.g., <500° C.) so that the oxidation of the compound occurs only after the rearrangement. Examples of such compounds are trimethyl trifluoromethyltin and dibutyltin diacetate. See '657, Gordon, columns 4 and 5.

### EXAMPLE

In the preparation of coating samples, fluorine (F) doped tin oxide films are deposited on various substrates by chemical vapor deposition by a process according to '657 Gordon. Substrates include 1″×1″ coupons of gold and SS 316 as well as 2″×2″ coupons of Al and Ti. Substrates preferably are polished and cleaned before loading them into the CVD furnace. Commercially available dibutyl tin diacetate ('657 Gordon) is used as the tin precursor and the deposition temperature is up to 500° C. An estimated 0.5 to 1% F-dopant level is achieved with a target value of final thickness of the sample at 1.0 micrometers. Typical parameters for the preparation of fluorine doped tin oxide can be found in several publications (R. Gordon, Journal of Non-Crystalline Solids 218 (1997) 81-91, and U.S. Pat. No. 4,146,657 Gordon).

The contact resistance of coatings, made by a process as described above according to '657 Gordon, was measured. This was done by compressing the sample in between two carbon paper diffusion papers (Toray) at 200 psig and applying 1A/cm² current. F-doped SnO₂ films were on one side of the substrate. The coatings as tested were estimated to have F-content of above 0.6 weight percent. The contact resistance was obtained from the voltage drop between the diffusion media (paper) and the metal coupon across the coating. The contact resistances did not change significantly before and after corrosion experiments, indicating good protection of the underlying Ti and SS substrates. The contact resistance, as coated on Ti was about 10 to 12 milliohms×cm². This indicates that the bulk conductivity of the coating should compare favorably to those reported in the literature, on the order of 1,000 Siemens per cm. The contact resistance was on the same order of magnitude as comparative Pt coated Ti and comparative conductive polymeric coating on Ti.

Low corrosion currents were observed while cycling the potential between +0.4 and +0.6 V (vs. Ag/AgCl) in aerated solution and between −0.5 and −0.4 V (vs. Ag/AgCl) in H₂-saturated solution at 80° C., simulating the bipolar plate environment for the cathode and the anode, respectively (pH=3.0, 10 ppm HF, and 0.5 molar Na₂SO₄ supporting electrolyte). Potentiostatic corrosion experiments were also conducted over 6 hours at both +0.6 V (Ag/AgCl, in air) and at −0.4 V (Ag/AgCl, in hydrogen) and the measured corrosion currents under these conditions were of the same order of magnitude, indicating good stability of the coating.

SEM micrographs were taken on samples before corrosion testing and on coatings which had been exposed to extended polarization at either +0.6 V (Ag/AgCl), in air) and at −0.4 V (Ag/AgCl, in hydrogen). SEM micrographs revealed a very dense layer with no observable defects, so that the coatings appeared nearly pore free. No changes in the coating were observed after the corrosion tests indicating good corrosion stability.

In summary, fluorine-doped SnO₂ was tested on titanium (Ti) and stainless steel (SS) under simulated fuel cell environment for its corrosion stability and also for its conductivity before and after corrosion. The results clearly showed no degradation.

As can be seen from the above description, due to the cell's hostile environment, coatings are useful on oxidizable metals (e.g., titanium or stainless steel) and on metals that are susceptible to dissolution in the fuel cell environment (e.g., aluminum). In the case of oxidizable metals, the oxide film formed in the fuel cell environment reduces contact and increases electrical resistance. This occurs due to the oxidizable/passivating nature of the metal (e.g., titanium or stainless steel) when exposed to the high temperature 60-100° C., the potentials, and acidic (i.e., HF) environment in the cell. Chemical corrosion of aluminum in this environment may lead to total dissolution. Thus, the coating of the invention makes it possible to use these metals, (i.e. SS, Ti and Al) in the fuel cell. The coating itself may consist of one or more layers. If there are voids in the layers of the coating, the coating is still very effective if the voids are small, dispersed, or not aligned. Thus, throughways or passages through the coating are minimized by multiple layers.

It is possible to also coat the sides of the electrical contact element facing the coolant flow channel. However, this is not strictly necessary since coolants are typically not corrosive. The manufacturing process may conveniently be one where coating of both faces is desired. The coating of the coolant face, though not necessary in current applications, is certainly possible and should be considered optional.

As stated earlier, the coating is preferably deposited onto the substrate using conventional PVD techniques (e.g., sputtering), or CVD techniques known to those skilled in the art. In addition, conductive coatings of different types are deposited by a variety of means. Various metal oxides, such as stannic oxide SnO₂, indium oxide In₂O₃, and cadmium stannate Cd₂SnO₄, have been the most widely used materials for forming transparent, electrically conductive coatings and layers. The intentional addition of certain impurities is important in these processes, in order to achieve high electrical conductivity and high infrared reflectivity. Thus, tin impurity is incorporated in indium oxide, while antimony is often added to tin oxide (stannic oxide) for these purposes. In each case the function of these desirable impurities (“dopants”) is to supply “extra” electrons which contribute to the conductivity. The solubility of these impurities is high, and they can be added readily using a variety of known deposition methods.

It is noted that a relatively low resistivity tin oxide film was reported in U.S. Pat. No. 3,677,814 to Gillery. Using a spray method, he obtained fluorine-doped tin oxide films with resistance as low as 15 ohms per square centimeter by utilizing a compound, as a starting material, which has direct tin-fluorine bonds. Newer deposition methods as disclosed in '657 Gordon, provide fluorine-doped tin oxide coatings of as low as 10⁻⁴ ohms-centimeter. This is equivalent to the low resistivity of much more expensive materials like tin doped indium oxide, which is not corrosion resistant, and is comparable to the films described in the Example above.

Methods of deposition and electrical and other properties of F-doped tin oxide film (SnO₂₋ₓ:F) can be found in a variety of references including: (1) Acosta et al., “About the structural, optical and electrical properties of SnO₂ films produced by spray pyrolysis from solutions with low and high contents of fluorine,” Thin Solid Films 288 (1996) 1-7; (2) Ma et al., “Electrical and optical properties of F-doped textured SnO₂ films deposited by APCVD,” Solar Energy Materials and Solar Cells 40 (1996) 371-380; (3) Sekhar et al., “Preparation and study of doped and undoped tin dioxide films by the open air chemical vapor deposition technique,” Thin Solid Films 307 (1997) 221-227; (4) Mientus et al, “Structural, electrical and optical properties of SnO₂₋ₓ:F-layers deposited by DC-reactive magnetron-sputtering from a metallic target in Ar—O₂/CF₄ mixtures,” Surface and Coatings Technology 98 (1998) 1267-1271 and (5) Suh, et al., “Atmospheric-pressure chemical vapor distribution of fluorine-doped tin oxide thin films” Thin Solid Films 345 (1999) 240-243.

The advantage of CVD prepared F-doped SnO₂ is that thick order of 10 micrometers (microns) and nearly pinhole free coatings can be prepared in a cost-effective manner. This provides corrosion protection for metals subject to dissolution oxidation and passivation in a fuel cell environment, including aluminum bipolar plates. In contrast to carbon/polymer composite coatings, F-doped SnO₂ is characterized by very low porosity and a low density of pinholes.

The coating of the invention facilitates use of relatively cheap and easily machinable metals, such as aluminum, titanium, and stainless steel as bipolar plate metals. Particularly in the case of aluminum, the required thickness of noble metal coatings for proper corrosion protection is very costly. Stainless steel and titanium on the other hand are largely resistant to corrosion, but a rapid formation of insulating oxides with a concomitant increase in contact resistance renders these materials commercially unattractive without protective coatings. Hence a relatively low-cost, conductive, and corrosion resistant coating provided by the present invention applied to aluminum, titanium, and stainless steel is highly desirable.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electrochemical cell comprising an ion conducting membrane, a catalytic electrode on one face of the membrane, a catalytic electrode on the other face of the membrane, and an electrically conductive contact element facing at least one of said electrodes for conducting electrical current from said one electrode, the improvement comprising said electrically conductive contact element having an electrically conductive coating comprising fluorine doped tin oxide.

2. The cell of claim 1 wherein said electrically conductive contact element comprises a metal substrate which is susceptible to corrosion, and said coating is a corrosion-resistant protective coating which protects said metal substrate from the corrosive environment of the cell.

3. The cell of claim 1 wherein said electrically conductive contact element comprises a substrate formed of electrically conductive particles dispersed in a binder matrix, and said coating provides electrical contact between said substrate and said one electrode.

4. The cell of claim 1 wherein said electrically conductive contact element comprises a matrix of compacted graphite flakes impregnated with a filler.

5. The cell of claim 1 wherein said electrically conductive contact element comprises a conductive substrate, a layer of conductive open cell foam having a first face facing said substrate and a second face facing said one electrode, and wherein said coating is on said second face of said foam layer.

6. The cell of claim 5 wherein said open cell foam has external surfaces and internal surfaces defined by openings in said open cell foam, and wherein said coating is on said internal and external surfaces.

7. The cell of claim 6 wherein said foam has a thickness between said first and second faces, and said coating is present on said internal and external surfaces throughout said thickness.

8. The cell of claim 7 wherein said coating is on a surface of said substrate facing said foam.

9. The cell of claim 5 wherein said substrate is a metal sheet and said foam is a metal foam.

10. The cell of claim 9 wherein said metal sheet is welded or braised to said metal foam.

11. The cell of claim 1 which further includes an electrically conductive porous material disposed between said one electrode and said coated electrically conductive contact element, and wherein, said porous material is selected from the group consisting of carbon paper, carbon cloth and metal screen.

12. An electrically conductive fluid distribution element for an electrochemical cell comprising:
an electrically conductive substrate having first and second major surfaces, a flow field at said first major surface for distributing fluid along said first major surface, the improvement comprising, an electrically conductive coating on said first major surface which comprises fluorine doped tin oxide.

13. The element of claim 12 wherein the said substrate is selected from the group consisting of titanium, stainless steel, aluminum, a composite of electrically conductive particles dispersed in a binder matrix; and compacted graphite flakes impregnated with a filler.

14. The element of claim 12 wherein said flow field comprises a layer of electrically conductive open cell foam.

15. The element of claim 14 wherein said foam is conductive graphite foam or conductive metallic foam.

16. The element of claim 12 wherein said flow field comprises a series of channels in said first major surface.

17. The element of claim 12 wherein said flow field comprises lands defining a plurality of grooves for distributing fuel or oxidant along said first major surface.

18. The element of claim 12 which comprises a second flow field at said second major surface.

19. The element of claim 18 wherein said second flow field comprises lands defining a plurality of grooves for distributing coolant fluid along said second major surface.

20. The element of claim 12 wherein the fluorine content of said fluorine doped tin oxide is less than 10 weight percent.

21. A method for inhibiting degradation of an electrically conductive contact element in an electrochemical cell, said cell having a proton conductive material which degrades leading to formation of corrosive species in the cell, said method comprising, including in said cell, a layer comprising fluorine doped tin oxide between said proton conductive material and said electrically conductive contact element, to thereby inhibit corrosion of said electrically conductive contact element.

22. The method of claim 21 wherein the proton conductive material comprises perfluoronated sulfonic acid polymer.

23. The method of claim 21 wherein the proton conductive material comprises perfluorocarbon sulfonic acid polymer and polytetrafluoroethylene.
